(19) United States
(12) Patent Application Publication
(10) Pub. No.: US 2021/0359500 A1
(43) Pub. Date: Nov. 18, 2021

(54) SEALING APPARATUS

(71) Applicant: Nidal Qumsieh, Sunbury (AU)

(72) Inventor: Nidal Qumsieh, Sunbury (AU)

(21) Appl. No.: 17/282,350

(22) PCT Filed: Feb. 10, 2019
(86) PCT No.: PCT/AU2019/051068

§ 371 Date: Apr. 1, 2021

(30) Foreign Application Priority Data
Oct. 2, 2018 (AU) 2018903722

(51) Int. Cl. H02G 3/22; F16J 15/02; H02G 3/06; E04D 13/14

(52) U.S. Cl. CPC H02G 3/22; E04D 13/1415; H02G 3/0691; F16J 15/021

(57) ABSTRACT

A sealing apparatus for sealing against an opening in a structure for establishing a sealed passage therethrough, comprising a main body having opposed first and second sides, a first hollowed portion projecting from the first side, a second hollowed portion projecting from the second side and a flange between the first and second hollowed portions, the first and second hollowed portions communicating with one another to define a sealed passage for allowing a cable/pipe to pass therethrough.

### FIELD OF THE INVENTION

The present invention relates to a sealing apparatus for use with roof-mounted devices such as air conditioning units which require cabling and pipes to penetrate through a roof.

### BACKGROUND

Frequently, air conditioning units are mounted on roofs. The benefits of such systems include better security from vandalism or accidental damage, saving space and typically being quieter than ground units. In such installations, a suitable location on a roof is selected and the roof is cut to form an opening. Cabling and pipes are passed through the opening in the roof and connected to the outside device. The opening is then usually sealed using Dektite™ flashing and silicon to prevent water and debris ingress through the opening in the roof.

However, there are drawbacks associated with the existing methods of installing roof-mounted devices and sealing the roof opening. UV and general weather degradation of the flashing over time may result in leaks into the roof. By the time the material degradation is discovered, it has often resulted in significant damage to internal components in the roof. The damage can also be dangerous if the electrical cables are exposed to water and debris, creating hazards for workers performing repairs.

Preferred embodiments of the present invention provide a sealing apparatus for use in installing a roof-mounted device and seek to address the above problems.

### SUMMARY

According to a first aspect of the present invention, there is provided a sealing apparatus for sealing against an opening in a structure for establishing a sealed passage therethrough, comprising a main body having opposed first and second sides, a first hollowed portion projecting from the first side, a second hollowed portion projecting from the second side and a flange between the first and second hollowed portions, the first and second hollowed portions communicating with one another to define a sealed passage for allowing a cable/pipe to pass therethrough.

The structure could be a roof or any other structure (such as a wall, floor or any other part of a building) through which cables/pipes may need to pass for installing a device or system.

According to a second aspect of the present invention, there is provided a method of providing passage for a cable/pipe of a device through an opening in a structure using the sealing apparatus of any one of the preceding claims, comprising inserting the first hollowed portion into an opening in the structure such that the flange abuts a portion of a surface of the structure surrounding the opening, sealing the flange against the surface, feeding the cable/pipe through the sealing apparatus, and securing the cable/pipe to the device.

In certain embodiments, the sealing apparatus may include an elongate sheath attachable to the second hollowed portion so as to surround an opening of the second hollowed portion. The elongate sheath may be formed of ethylene propylene diene monomer (EPDM rubber) and has a diameter substantially similar to the second hollowed portion for providing a sealed connection for cables/pipes to pass through. The elongate sheath is waterproof and bendable/malleable to follow the path of the cables/pipes. For example, in use, the elongate sheath may be arranged in an inverted U-shape with both ends directed downwardly toward the structure, away from possible water sources. Additionally, the sheath may be collapsible, so that it can be compressed and clamped about the cables/pipes passing therethrough.

When used for pipes, for example for air conditioning units, the diameter of the elongate sheath may be approximately 62 mm. However, depending on the application, different sizes of sheaths and corresponding hollowed portion sizes can be used, for example, 100 mm, 150 mm, 200 mm, 250 mm or 315 mm. For applications where the sealing apparatus and sheath is required to provide sealed passage for electrical cables only (and not pipes), the elongate sheath may have a diameter of approximately 20 mm, 25 mm, 32 mm or 40 mm. For larger applications, including heavy duty fans for restaurants and other industrial environments, the diameter may be of greater size, for example, 400 mm, 500 mm, 600 mm, 680 mm or 800 mm.

Optionally, separate passage may be provided for electrical cables through one sealing apparatus while another sealing apparatus is provided adjacent for passage of pipes.

The sealing apparatus may further include a rubber elbow situated between the elongate sheath and the device.

### BRIEF DESCRIPTION

The present invention will now be described, by way of non-limiting example only, with reference to the accompanying drawings, in which:

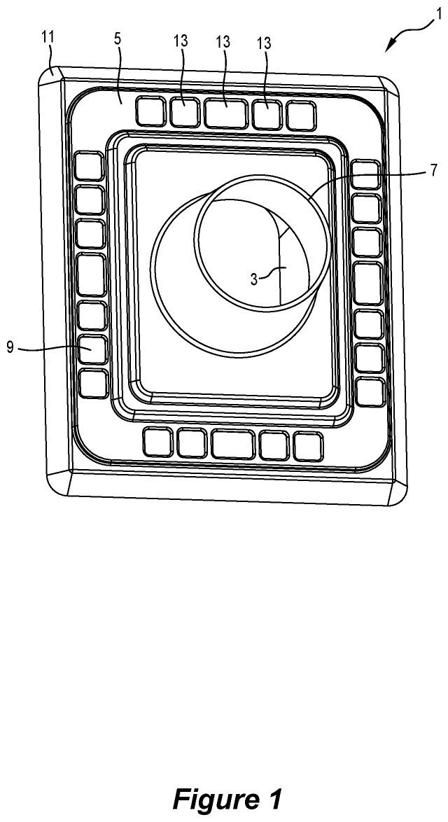

FIG. 1 is a top view of a sealing apparatus;

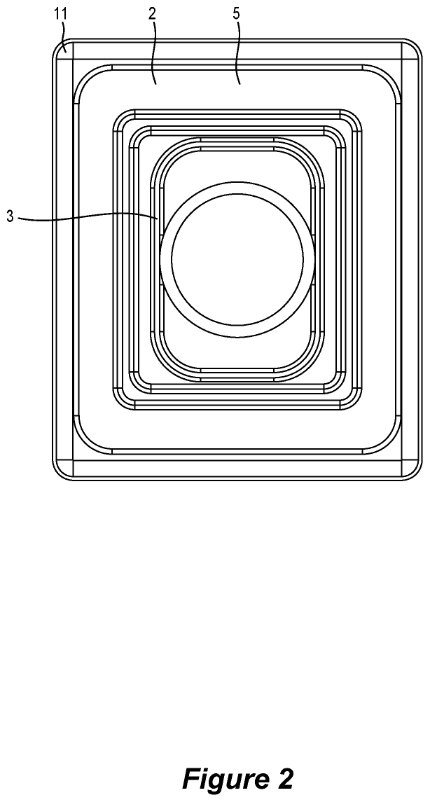

FIG. 2 is a bottom view of the sealing apparatus of FIG. 1;

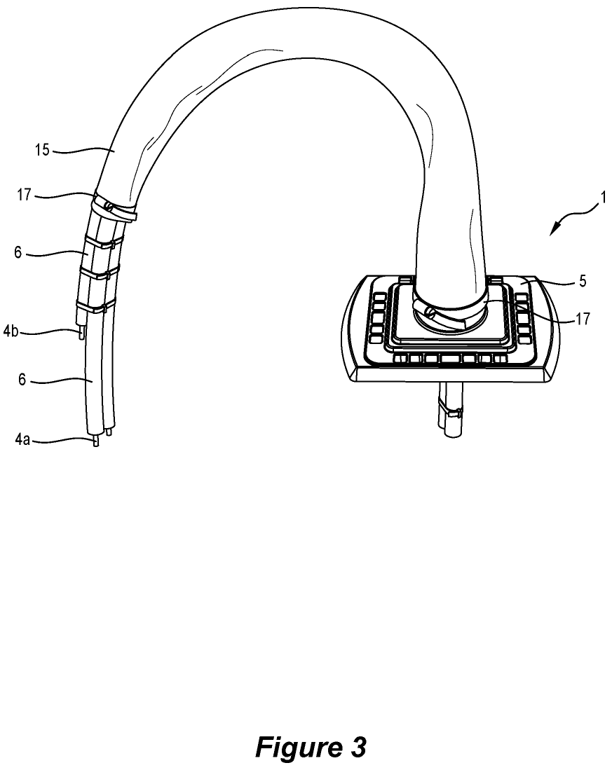

FIG. 3 is a side view of the sealing apparatus assembled with a sheath and clamps;

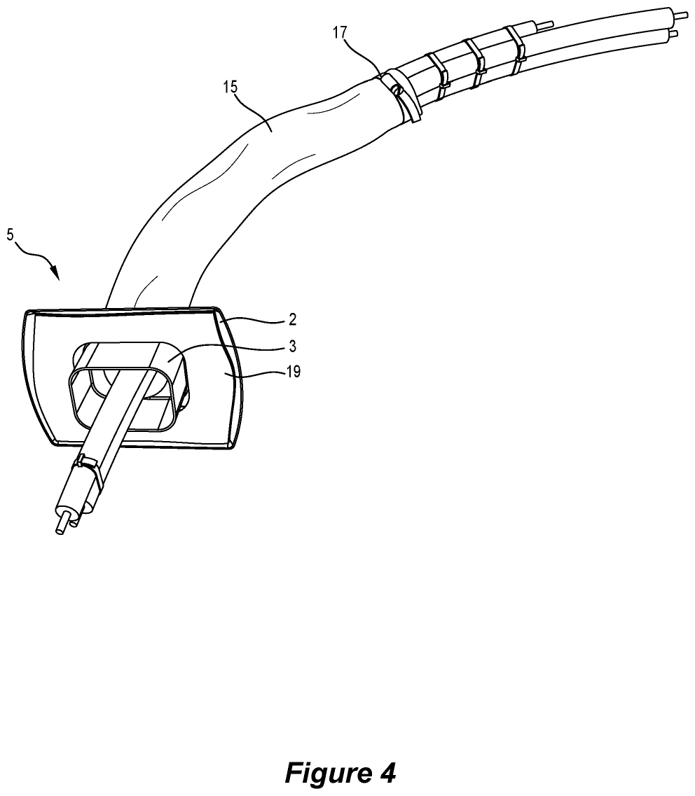

FIG. 4 is a bottom view of the sealing apparatus assembled with a sheath and clamps and an adhesive gasket;

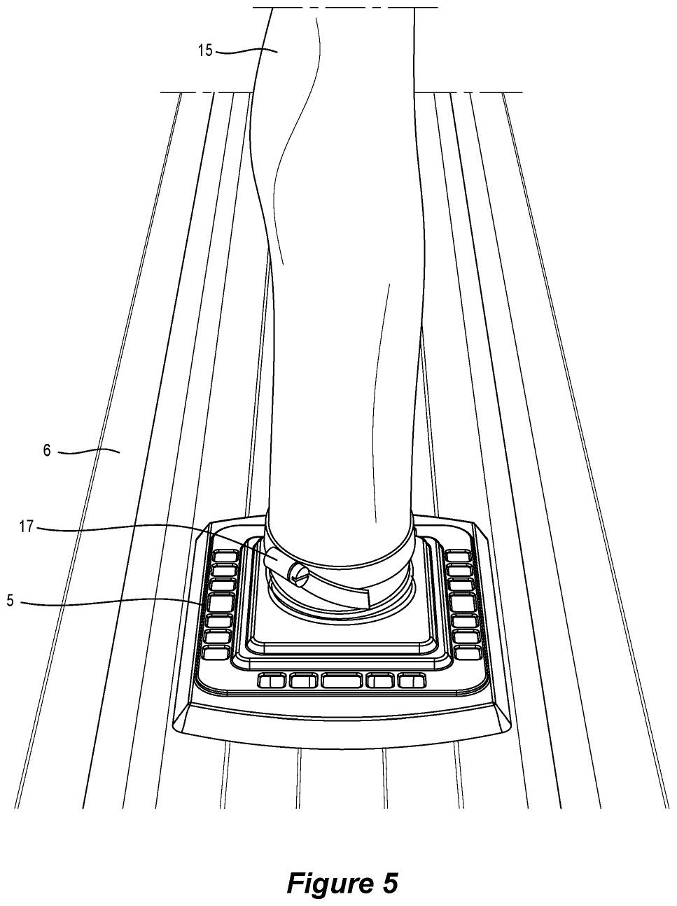

FIG. 5 shows the sealing apparatus assembled in an opening in a roof;

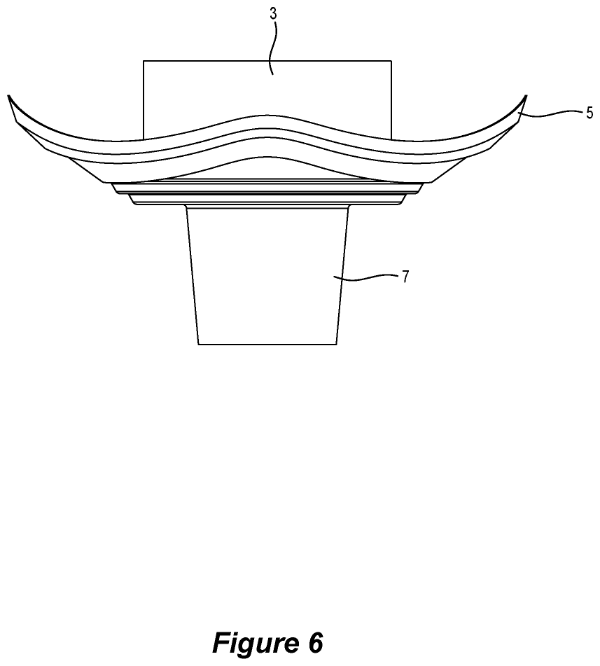

FIG. 6 is a side view of the sealing apparatus in a deformed state; and

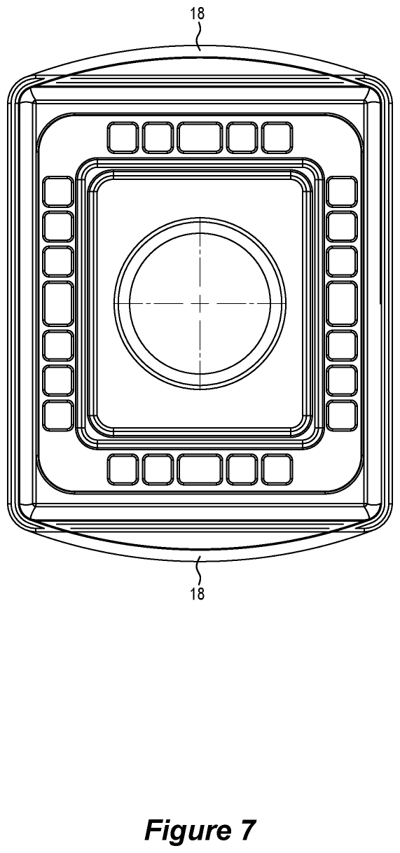

FIG. 7 shows a sealing apparatus according to another embodiment.

### DETAILED DESCRIPTION

FIG. 1 is a top view of a sealing apparatus 1 comprising a first hollowed portion 3 (partially obscured in this view) and a second hollowed portion 7. The sealing apparatus 1 includes a flange 5, which includes a deformable frame 9 and an elastomeric portion 11 encasing the frame 9. Cut-out portions 13 are included to accommodate deformation of the flange 5. Preferably the flange includes ethylene propylene diene monomer (EPDM rubber), or any other suitably weather-resistant sealing material.

FIG. 2 is a bottom view of the sealing apparatus 1, showing first hollowed portion 3 for insertion into an opening of a structure (not shown). The underside 2 of sealing apparatus 1 is recessed to receive a gasket for sealing against a surface of the structure.

FIG. 3 is a side view of the assembled sealing apparatus 1. Pipes 4a and cables 4b are wrapped with insulating materials 6 and passed through the second hollowed portion 7 (obscured in this view) and out of the first hollowed portion 3. A sheath 15 is slid over the pipes 4a and cables 4b and secured over the second hollowed portion 7. The sheath 15 is secured to the second hollowed portion and pipes/cables 4a/4b by clamps 17.

Advantageously, the sheath 15 may provide further insulation to the pipes, thereby increasing efficiency of the device.

FIG. 4 is a bottom view of the sealing apparatus. A double-sided adhesive gasket 19 is applied to flange 5 by peeling off one layer of the protective covering to expose an adhesive surface and applying the gasket 19 to the underside 2 of the flange 5. Preferably, the gasket is formed of 2 mm thick butyl rubber sheet. Upon installation of the sealing apparatus to a structure, the other layer of protective covering is removed to expose a second adhesive surface which is applied to the structure surface, securing the sealing apparatus about an opening in the roof. FIG. 5 shows the sealing apparatus 1 installed on a structure, where the structure is a roof 6. Advantageously, the flange 5 is rectangular in shape, providing a suitable surface area for engagement with a corrugated roof surface.

In an alternative embodiment not shown in the figures, the clamps 17 can be replaced by pieces of double-sided adhesive gasket applied to the elongate sheath 15 and the cables/pipes 4a/4b. A similar piece can be applied to secure the elongate sheath 15 to the second hollowed portion 7.

FIG. 6 shows the sealing apparatus 1 in a deformed state, whereby the deformable frame within flange 5 is manipulated to adapt to the contour of a surface of a structure. When adapted to the contours of a corrugated roof surface, for example, this allows water to flow over the surface of the flange without leakage into the roof cavity. Advantageously, as shown in FIG. 7, the flange 5 may further include curved portions 18 at its edges for guiding water away from the underside of the sealing apparatus 1 to flow along the roof past the sides of the flange 5.

As the hollowed portions communicate directly with one another, there is a protected path through which the cables and/or pipes can travel from the outside, connected to the device, to the inside of the roof. Advantageously, as the first hollowed portion projects through the opening in the roof, this may help to avoid dislodgment of the sealing apparatus and also protects the cables and/or pipes from the cut surface of the opening in the roof. Preferably, the first and second hollowed portions are formed integrally with the main body of the sealing apparatus.

In certain embodiments, the sealing apparatus may include an elongate sheath attachable to the second hollowed portion for protecting cables and/or pipes. Alternatively, the second hollowed portion itself may be configured to protect the cables and/or pipes passing through the sealing apparatus. The elongate sheath may be 2 mm thick tubular rubber.

In certain embodiments, the gasket and adhesive surface may be formed integrally with the underside of the sealing apparatus so that a user need only remove one protective layer to place and seal the sealing apparatus on the structure.

It will be understood that embodiments of the sealing apparatus may be used for installation of various devices, such as solar devices, plumbing, roof ducts, rangehood ventilation and other ventilation, water and gas pipes, and other equipment. Additionally, it will be understood that although embodiments of the invention are highly suited to installation of devices on roofs, certain embodiments may be to any structure where sealing against water ingress and debris is desired. Such applications may include walls, floors and internal structures.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A sealing apparatus for sealing against an opening in a structure for establishing a sealed passage therethrough, comprising a main body having opposed first and second sides, a first hollowed portion projecting from the first side, a second hollowed portion projecting from the second side and a flange between the first and second hollowed portions, the first and second hollowed portions communicating with one another to define a sealed passage for allowing a cable/pipe to pass therethrough.

2. The sealing apparatus of claim 1, wherein the apparatus includes an elongate sheath attachable to the second hollowed portion so as to surround an opening of the second hollowed portion.

3. The sealing apparatus of claim 2, further comprising at least one clamp for securing the elongate sheath to the cable/pipe.

4. The sealing apparatus of claim 2, further comprising at least one clamp for securing the elongate sheath to the second hollowed portion.

5. The sealing apparatus of claim 1, wherein the flange comprises an elastomeric material for sealing against a surface of the structure.

6. The sealing apparatus of claim 1, wherein the flange comprises a deformable frame which can be manipulated to conform to the surface of the structure on which the sealing apparatus is placed.

7. The sealing apparatus of claim 5, wherein the flange comprises a deformable frame which can be manipulated to conform to the surface of the structure on which the sealing apparatus is placed, and wherein the elastomeric material substantially encases the deformable frame.

8. The sealing apparatus of claim 7, wherein the flange includes cut-out portions in the elastomeric material to accommodate deformation of the flange.

9. The sealing apparatus of claim 1, wherein the sealing apparatus includes an adhesive surface for securing the flange to the structure.

10. The sealing apparatus of claim 2, wherein, in use, the elongate sheath forms an inverted U-shape with both ends of the sheath directed downwardly toward the structure.

11. A method of providing passage for a cable/pipe of a device through an opening in a structure using the sealing apparatus of claim 1, comprising inserting the first hollowed portion into an opening in the structure such that the flange abuts a portion of a surface of the structure surrounding the opening, sealing the flange against the surface, feeding the cable/pipe through the sealing apparatus, and securing the cable/pipe to the device.

12. The method of claim 11, further comprising sliding the elongate sheath over the cable/pipe prior to securing the cable/pipe to the device.
